(19) United States
(12) Patent Application Publication
(10) Pub. No.: US 2020/0108441 A1
(43) Pub. Date: Apr. 9, 2020

(54) MANUFACTURING METHOD

(71) Applicant: ROLLS-ROYCE POWER ENGINEERING PLC, Derby (GB)

(72) Inventor: Thomas S JONES, Derby (GB)

(73) Assignee: ROLLS-ROYCE POWER ENGINEERING PLC, Derby (GB)

(21) Appl. No.: 16/585,827

(22) Filed: Sep. 27, 2019

(30) Foreign Application Priority Data
Oct. 3, 2018 (GB) 1816144.8

(51) Int. Cl. B22F 3/105; B33Y 10/00

(52) U.S. Cl. CPC B22F 3/1055; B22F 2003/1058; B33Y 10/00

(57) ABSTRACT

The present disclosure relates to a method of manufacturing a component (e.g. a component having an overhang) by additive layer manufacturing. The method comprises forming the component and at least one support structure by consolidating consecutive layers of deposited powder material using a heat source. The component and the support structure are at least partially spaced by a void containing unconsolidated powder material. The void may be bridged by bridge portions of consolidated powder material equally spaced along the void.

This disclosure claims the benefit of UK Patent Application No. GB 1816144.8, filed on 3 Oct. 2019, which is hereby incorporated herein in its entirety.

### FIELD OF THE DISCLOSURE

The present disclosure relates to additive layer manufacturing method for producing a component. In particular, the disclosure relates to an additive layer manufacturing method for reducing post-build processing requirements.

### BACKGROUND OF THE DISCLOSURE

Components manufactured by additive layer manufacturing (ALM) methods can have significant performance, weight, cost and lead time advantages over components manufactured by more traditional methods.

Powder bed ALM methods construct components layer by layer by depositing powder on a base plate and then selectively consolidating the powder using a laser or other heat source. These steps are repeated to produce a three dimensional component.

ALM methods are unable to produce components with overhangs greater than 45 degrees. For such overhangs, support structures are required to prevent build failures. These support structures are built up layer upon layer along with the component. The support structures are subsequently removed from the component and disposed of.

Removal of the support structures is typically carried out manually using hand tools or machine tools. These processes add significant time, cost and limits to possible geometry of the resultant component. Furthermore, unless the surface of the component is completely machined, subsequent dressing of components to remove the “witness lines” remaining after the removal of the support structures is often necessary especially in areas sensitive to surface finishing.

Small contact supports are known and these can be removed more easily but the surface finish is often very rough as a result of small peaks remaining where the small contact supports were in contact and the sintering of powder particles onto the surface in between the supported points.

There is a desire to provide a method that ameliorates at least some of the problems associated with the known methods.

### SUMMARY OF THE DISCLOSURE

In a first aspect, the present disclosure provides a method of manufacturing a component by additive layer manufacturing, said method comprising forming the component and at least one support structure by consolidating consecutive layers of deposited powder material using a heat source wherein the component and the support structure are at least partially spaced by a void containing unconsolidated powder material.

The support structure formed of consolidated powder material and the void containing unconsolidated powder act to support the build of the component, especially where the component comprises an overhang of greater than 45 degrees to the vertical. Furthermore, the consolidation of the powder material into the at least one support structure limits the volume of powder material available for sintering onto the surface of the component to that contained within the void such that the surface finish is less rough. If the consolidated support structure was not provided, the unconsolidated powder bed below/adjacent the component would provide a large volume of powder for sintering onto the component surface.

Optional features will now be set out. These are applicable singly or in any combination with any aspect.

The method comprises forming the component and the at least one support structure (e.g. a plurality of support structures) by additive layer manufacturing using a powder material. The powder material may be a metal or metal alloy e.g. nickel, copper, iron, steel, nickel alloys, titanium, titanium alloys, magnesium, magnesium alloys, aluminium, aluminium alloys, vanadium, zirconium, hafnium, or refractory metals such as niobium, molybdenum, tantalum, tungsten and rhenium. The powder material may be ceramic, metallic-ceramic combination or metal matrix composite e.g. from zirconium, yttria or silicon carbide.

The additive layer manufacturing method comprises depositing and selectively consolidating consecutive layers of powder material using a heat source (e.g. a laser source or electron beam). This step is repeated multiple times so that the consolidated horizontal cross-sections of the component and at least one support structure formed in each layer stack up layer upon layer in the vertical build direction to form the three dimensional component and at least one support structure.

In some embodiments, the method comprises consolidating the deposited powder material in each layer to form the horizontal cross-section of the at least one support structure prior to consolidating the deposited powder material in the layer to form the horizontal cross-section of the component. Again, this helps to reduce the volume of unconsolidated powder available for sintering onto the surface of the component.

In some embodiments, the void has a thickness equal to the thickness one or more of the deposited layers of powder material. For example, the void may have a thickness of 2 or more e.g. 2 to 5 times the thickness of a deposited layer of powder material. The powder material in the void may be provided by not exposing the powder material in the void to the heat source in the so that the powder remains unconsolidated.

In some components, the method may comprise forming the component having an overhang and forming the support structure below the overhang with the void containing unconsolidated powder spacing the overhang and the support structure. The overhang may be at an angle of 45 degrees or more to the vertical.

The method may further comprise forming at least one bridge portion of consolidated material bridging the overhang of the component and the support structure. The bridge portion is preferably formed by heating the consolidated powder material forming the overhang to form a melt pool that extends through the void to the support structure. As the melt pool extends through the void to the support structure, it will cool sufficiently such that it is unable to melt the surface of the support structure. Accordingly, the bridge portion formed will be in contact, but may not be bonded to the support structure.

In some embodiments, the method comprises forming a plurality of bridge portions e.g. a plurality of bridge portions substantially equally spaced along the void.

In this way, the support structure is partially bonded to the overhang of the component which provides support to the overhang but which allows for easy post-build separation of the component and support structure along the void

The method may be used to form a component of a gas turbine engine.

In a second aspect, there is provided a component manufactured according to the first aspect.

In a third aspect, there is provided a gas turbine engine comprising a component manufactured according to the first aspect.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 shows a component with an associated support structure;

FIG. 2 shows the formation of a bridge portion across the void between the component and the support structure;

FIG. 3 shows a plurality of bridge portions along the void; and

FIG. 4 shows a number of component/support arrangements.

### DETAILED DESCRIPTION AND FURTHER OPTIONAL FEATURES OF THE DISCLOSURE

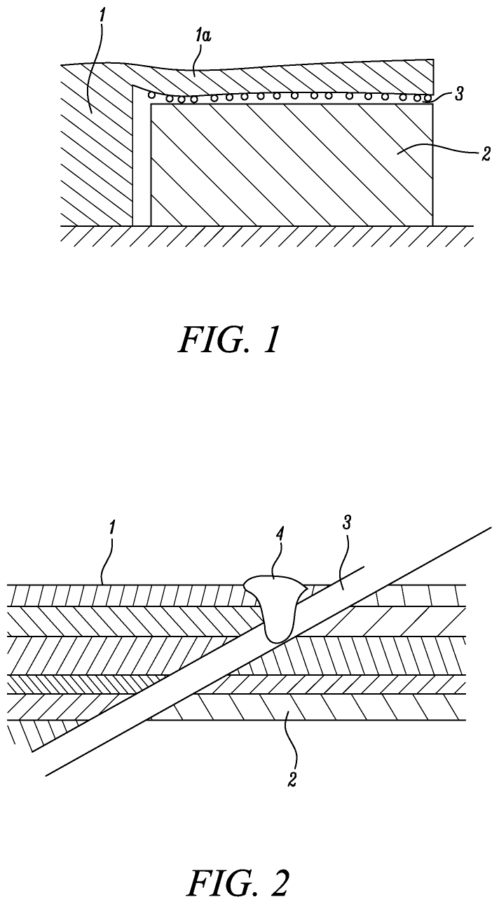

FIG. 1 shows a component 1 having an overhang 1a which is spaced from a support structure 2 by a void 3 containing unconsolidated powder material.

The component 1 and support structure 2 are both formed by additive layer manufacturing by depositing and selectively consolidating consecutive layers of a powder material using a laser source.

The deposited powder material in each layer is first consolidated to form a horizontal cross-section of the support structure 2 prior to the formation of the horizontal cross-section of the component 1.

This step is repeated multiple times so that the consolidated horizontal cross-sections of the component 1 and the support structure 2 formed in each layer stack up layer upon layer in the build direction to form the three dimensional component 1 and support structure 2.

The void 3 containing unconsolidated powder material is formed by not exposing one or more e.g. 2 or more layers of the deposited power material to the laser source so that the powder material remains unconsolidated. Thus the void and layer of unconsolidated powder material have a thickness of one or more (e.g. 2 or more) times the thickness of each deposited layer of powder material.

The support structure 1 and the void 3 containing unconsolidated powder act to support the build of the overhang 1a of the component 1.

The consolidation of the powder material into the support structure 2 limits the volume of powder material available for sintering onto the surface of the overhang 1a of the component 1 to that contained within the void 3 such that the surface finish of the overhang is less rough. If the support structure 2 was not provided, the unconsolidated powder bed below/adjacent the overhang 1a component 1 would provide a large volume of powder for sintering onto the overhang 1a surface.

FIG. 2 shows a second embodiment of a component 1 having a 45 degree overhang spaced from the support structure 2 by a void 3 containing unconsolidated powder material. Each of the component 1 and support structure 2 are formed of consolidated layers of powder material. The uppermost consolidated layer of the component 1 is heated using the laser source to form a melt pool 4 what melts though the lower layers of the component 1 and into the void 3.

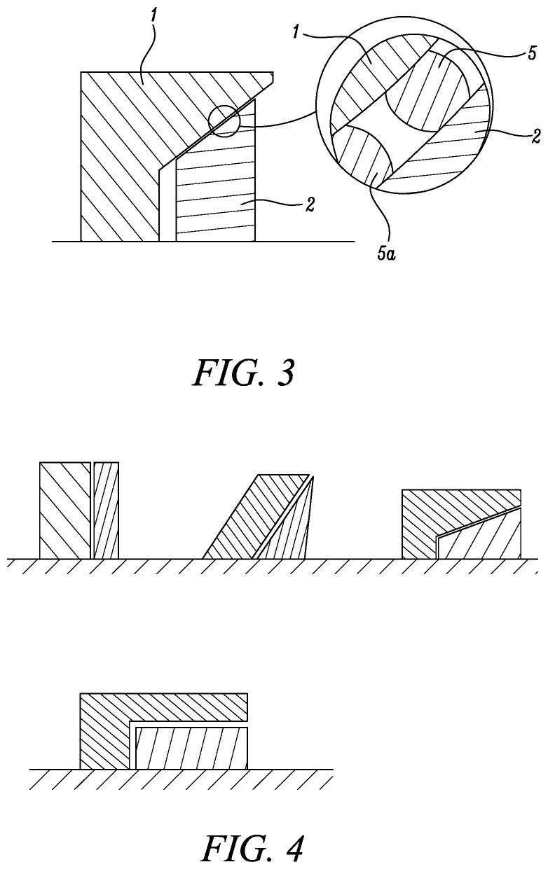

When the melt pool cools, a bridge portion 5 is formed between the component 1 and the support structure 2 as shown in FIG. 3. A plurality of equally spaced bridge portions 5, 5a are formed along the void.

These bridge portions 5, 5a help to support the overhang of the component 1 during formation but allow easy separation of the component 1 and support structure 2 post-build with minimal surface processing required.

FIG. 4 shows a number of different component and support structure arrangements that can be formed using the method described herein. Even when the component includes no overhang or an overhang at an angle of less than 45 degrees to the vertical, the method described herein is useful for improving surface finish as the consolidated support structure limits the volume of powder available for sintering onto the surface of the component facing the support structure.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A method of manufacturing a component by additive layer manufacturing, said method comprising forming the component and at least one support structure by consolidating consecutive layers of deposited powder material using a heat source wherein the component and the support structure are at least partially spaced by a void containing unconsolidated powder material.

2. The method according to claim 1 comprising depositing and consolidating the powder material in each layer to form a horizontal cross-section of the at least one support structure prior to consolidating the powder material to form the horizontal cross-section of the component.

3. The method according to claim 1 wherein the void has a thickness equal to the thickness of one or more of the layers of deposited powder material.

4. The method according to claim 3 wherein the void has a thickness equal to the thickness of between 2 to 5 layers of deposited powder material.

5. The method according to claim 1 comprising forming the component having an overhang and forming the support structure below the overhang with the void containing unconsolidated powder spacing the overhang and the support structure.

6. The method according to claim 5 further comprising forming at least one bridge portion bridging the overhang of the component and the support structure by heating the consolidated powder material forming the overhang to form a melt pool that extends through the void to the support structure.

7. The method according to claim 6 comprising forming a plurality of bridge portions substantially equally spaced along the void.

8. The method according to claim 1 wherein the component is a component of a gas turbine engine.

9. A component manufactured according to the method of claim 1.

10. A gas turbine engine comprising a component according to claim 9.
